(19) United States
(12) Patent Application Publication
(10) Pub. No.: US 2025/0211459 A1
(43) Pub. Date: Jun. 26, 2025

(54) VIRTUAL ENVIRONMENT MODIFICATIONS BASED ON USER BEHAVIOR OR CONTEXT

(71) Applicant: Intel Corporation, Santa Clara, CA (US)

(72) Inventors: Glen J. Anderson, Beaverton, OR (US); Aleksander Magi, Portland, OR (US); Sean J.W. Lawrence, Bangalore (IN)

(21) Appl. No.: 18/395,162

(22) Filed: Dec. 22, 2023

(51) Int. Cl. H04L 12/18; H04L 65/1069; H04L 65/1089; H04L 65/403

(52) U.S. Cl. CPC H04L 12/1831; H04L 65/1069; H04L 65/1089; H04L 65/403

(57) ABSTRACT

In one embodiment, a virtual environment is instantiated to provide a virtual two-dimensional or three-dimensional space in which a plurality of users can interact. Interactions by the plurality of users within the virtual environment are classified, and a topic of interest for a particular user in the classified interactions is identified based on a topics of interest model for the particular user. A response action is then initiated in a local execution of the virtual environment presented to the particular user based on the identified topic of interest. The topics of interest model may be generated by content associated with the particular user, e.g., stored on a user device of the particular user or in a cloud storage account of the particular user.

### BACKGROUND

Currently, immersive virtual environments (e.g., Metaverse®, Microsoft Teams®, or environments by Spatial®) are growing in capability and popularity for both leisure and professional use cases. However, there is a key user experience gap that is not being fulfilled by today's solutions; that is, users might not be alerted to or otherwise made aware of conversations happening in the environment that may be of some interest to them.

### BRIEF DESCRIPTION OF THE DRAWINGS

FIG. 1 illustrates an example system implementing a virtual environment in accordance with embodiments of the present disclosure.

FIG. 2 illustrates a block diagram of system components for implementing a virtual environment in accordance with embodiments of the present disclosure.

FIG. 3 illustrates aspects of an example virtual environment being modified based on user behavior or context in accordance with embodiments of the present disclosure.

FIG. 4 illustrates a flow diagram of an example process of modifying a virtual environment based on user behavior or context in accordance with embodiments of the present disclosure.

FIG. 5 illustrates a simplified block diagram of a computing device in which aspects of the present disclosure may be incorporated.

FIG. 6 is a block diagram of computing device components which may be included in a mobile computing device incorporating aspects of the present disclosure.

FIG. 7 is a block diagram of an exemplary processor unit that can execute instructions.

### DETAILED DESCRIPTION

In the following description, specific details are set forth, but aspects of the technologies described herein may be practiced without these specific details. Well-known circuits, structures, and techniques have not been shown in detail to avoid obscuring an understanding of this description. “An embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact. Terms modified by the word “substantially” include arrangements, orientations, spacings, or positions that vary slightly from the meaning of the unmodified term. For example, description of a lid of a mobile computing device that can rotate to substantially 360 degrees with respect to a base of the mobile computing includes lids that can rotate to within several degrees of 360 degrees with respect to a device base.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to aspects of the present disclosure, are synonymous.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims. While aspects of the present disclosure may be used in any suitable type of computing device, the examples below describe example mobile computing devices/environments in which aspects of the present disclosure can be implemented.

Aspects of the present disclosure provides techniques for modifying a virtual environment presented to a user based on the user's behavior or context within the environment. More particularly, some embodiments may implement a “cocktail party effect” inside virtual environments. When an individual is engaged in a real-world conversation in a large, crowded room, that person naturally tunes out the voices in the wider room as background noise, focusing just on immediate conversation with people nearby. However, when someone outside that conversation, but still within hearing range, is speaking about topic of interest to that individual or mentions a familiar name, that individual will start noticing the person speaking and might track or listen to the person. This is sometimes known as the “cocktail party effect”.

Some virtual spaces enable users to gather in virtual crowds, often represented by avatars in virtual two-dimensional or three-dimensional spaces. The virtual spaces can be presented on a computer screen, a virtual reality (VR) headset, or some other type of display. The interaction model can be fully immersive, as in a VR headset, or more like a 1st-person game, where the user moves within a virtual environment displayed on a screen in front of them (with the orientation of the screen changing accordingly). However, cocktail part effects have not been well implemented in these virtual spaces to provide a more natural user experience. Current approaches don't take advantage of a user's personal topics of interest to improve the benefits of the cocktail party effect. For example, they may replicate real-life limitations, present general topics, or simply increase volume of people closer by.

Embodiments herein may utilize a topic recognition model for a user, along with user behavior and/or context to modify various characteristics of the virtual environment presented to the user. Using the model, the virtual environment space can be monitored for words, conversations, images, etc. that the user may be interested in. and modify the environment presented to the user to call attention to those items. For example, the profile of conversations, words, images etc. that are identified as being of potential interest to the user can be raised so that the user can virtually “overhear” or see them in the virtual environment. This could include a “focusing” of audio (e.g., turning down irrelevant audio in the space and increasing audio related to the identified topic), a visual indicator (e.g., tags being displayed), a message to the user, or a spatial/visual re-orientation in the virtual environment (e.g., reorienting the virtual space so the user can see the user(s) discussing the potential topic of interest (e.g., shifting the view presented to show an image such as a piece of art or photo they might be interested in, or zooming into a location in the environment at which a potential conversation of interest is occurring), highlighting a user in the environment, etc.). Other modifications that can be made could include a reduction in noise or reduction in what is presented to the user from other users. For example, conversations not identified as potentially of interest can be reduced in volume or muted.

The topic recognition model may be primed with a user's digital history to give feedback to the user about conversations, conversants, imagery of interest, or other aspects relevant to the user's interests. For instance, the model may monitor a user's previous conversations (e.g., instant messaging conversations and/or verbal conversations in the virtual environment), social media posts or engagements, emails, images, etc. to generate a model of the user's topics of interest. Additionally, the model could ingest direct user inputs (e.g., via prompts for areas of interest) or allow for user adjustment of the model in real-time (e.g., if user is now uninterested in the topic, either temporarily or permanently). These areas of interest could be adaptable to environmental inputs, including, but not limited to: the virtual space the user is interacting in, the virtual participants they are with (e.g., the type (friends vs. family vs. colleagues) or the number (small group vs. large group)), or the time of week or day (weekday morning vs. weekend night). For example, a user may be interested in a work-related topic on a weekday morning surrounded by their work colleagues in a medium-sized gathering; however, on a weekend night, they might be uninterested in that topic and the model can adjust accordingly.

Confidentiality of content (vs user behavior indicators) could be estimated in multiple ways, for example, by a topic determination model that can analyze a corpus of documents labeled as “confidential” and produce a confidential topics list. The system could continuously monitor user input (before it is submitted to the virtual environment) for confidential topics and trigger user warnings and/or automated filtering for unknown or unsanctioned users. In addition, a user could audit such a list and add/delete topics or keywords as desired. Further, the user could adjust the “strictness” of confidentiality enforcement so that the system heavily weighs any confidential word match to topics. Confidentiality behavior indicators could be determined by tracking behavioral aspects, such as moving closer to a conversant in the virtual space, lower voice amplitude, a gesture such as putting a hand by one's mouth to show a whisper, or by other types of user inputs to the system. In some embodiments, conversations identified as being potentially sensitive in nature, e.g., due to their content or potential confidentiality restrictions on the topics, can be reduced in volume or muted to other users in the environment.

Advantages of embodiments herein will be readily apparent to those of skill in the art. As one example, a system incorporating aspects of the present disclosure can provide a more seamless—and natural—experience for end users of virtual environments in a wide spectrum of use cases including leisure, work, or education.

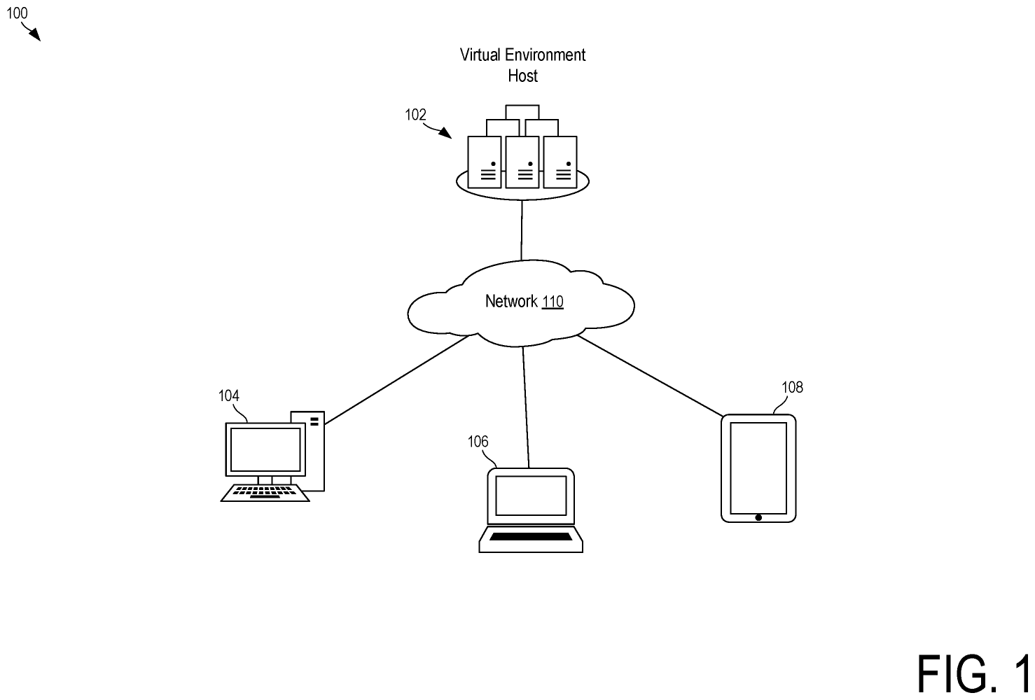

FIG. 1 illustrates an example system 100 implementing a virtual environment in accordance with embodiments of the present disclosure. The example system 100 includes a virtual environment host system 102 and user devices 104, 106, 108 connected together via a network 110. The virtual environment host system 102, which may include any number of computing devices (e.g., servers), executes an instance of an application to instantiate an immersive virtual environment in which users (e.g., users of the devices 104, 106, 108) can interact with each other. For example, the host 102 may instantiate an immersive virtual environment with virtual areas or spaces. The users may be represented by avatars or icons and may move within the virtual areas/spaces to interact with each other, e.g., send messages or have voice conversations with each other. The user devices 104, 106, 108 may instantiate a user-side execution of the application that connects to the application instances on the host 102. The users may control their representations (e.g., avatars) through input devices connected to the devices 104, 106, 108, e.g., through a keyboard, mouse, microphone, user-facing camera, virtual reality (VR) headset, or other types of input devices connected to the devices.

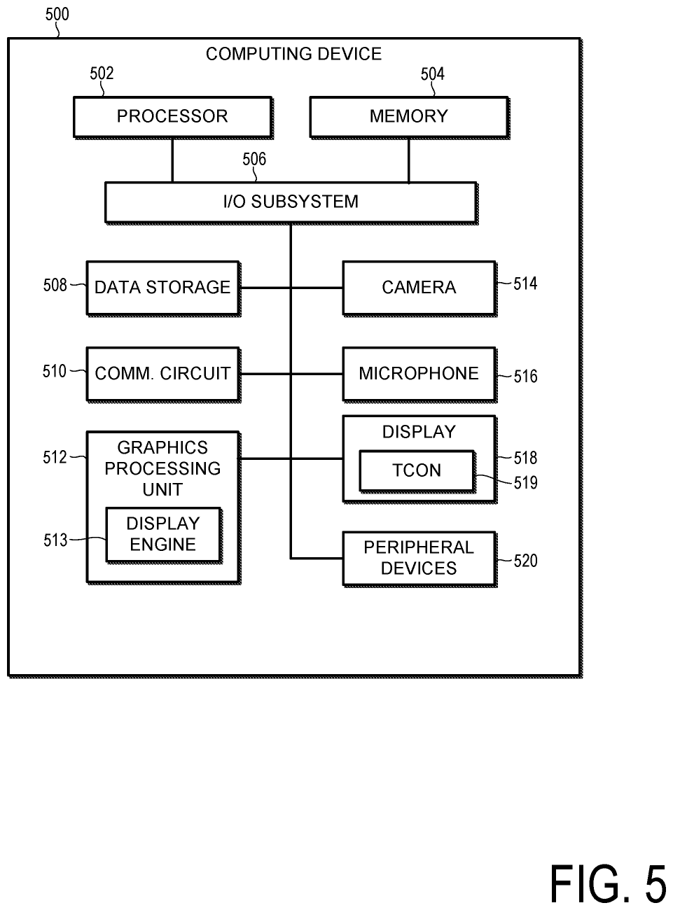

The user devices and the constituent virtual environment host system devices may be implemented as one or more computing devices as described below with respect to FIGS. 5-7, or may be virtualized instances of computing devices (e.g., applications executed in virtual machines or containers). The network 110 may be any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Further, the network 110 may include one or more networks.

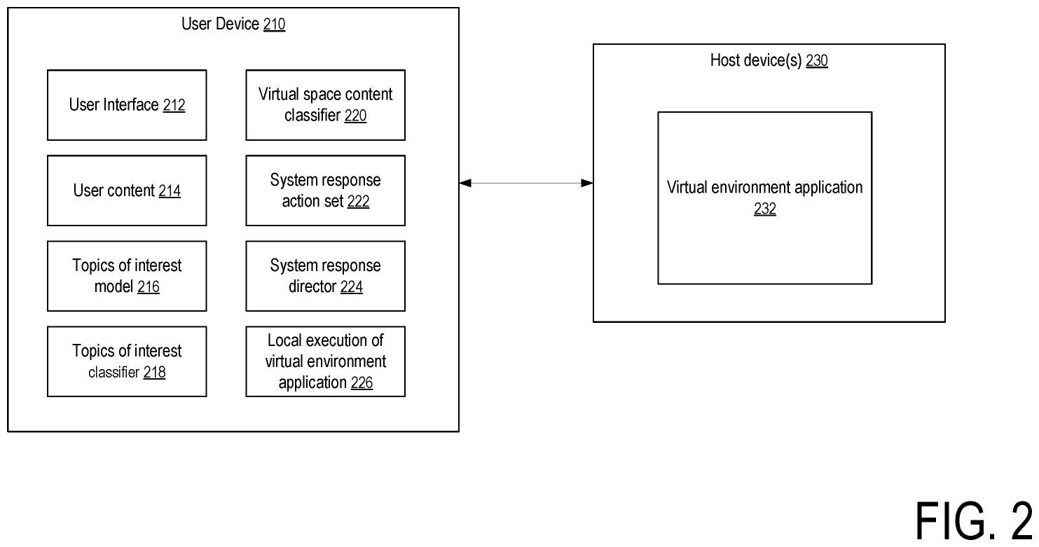

FIG. 2 illustrates a block diagram of system components for implementing a virtual environment in accordance with embodiments of the present disclosure. In particular, FIG. 2 illustrates hardware and software components of an example user device 210 and host device(s) 230 to execute a virtual environment as described above and herein. The host device(s) 230 may instantiate a cloud-based instance of a virtual environment 232, which may be any suitable virtual space in which users interact. For example, the virtual environment 232 may be implemented in a first-person video game, a metaverse application (e.g., a proto-metaverse application providing a virtual environment where social interaction is a key activity therein), or in an augmented or virtual reality environment. The host device(s) 230 can compose scene changes based on inputs from the many user devices (e.g., 210), and send the scene changes to the devices for display to the user.

The user device 210 executes a local execution (e.g., a scene) of the virtual environment 226 to implement view of the virtual environment to the user of the device on a display. The user device 210 includes a user interface 212 that generates and presents the virtual environment space to the user on the device based on inputs from the user and updates to the virtual environment 232 sent by the host device(s) 230. The user interface 212 may include output devices such as a computer display, VR headset, or another type of display, and input devices such as a keyboard, mouse, gamepad, touch screen, handheld controllers, gestures, eye gaze, etc. The interaction model for the environment may be fully immersive with the user's physical movements being replicated in the virtual environment, e.g., as with a VR headset, or may be like a first-person video game wherein the user inputs to, e.g., a keyboard or mouse, cause changes/interactions with the virtual environment, with the changes being displayed on a screen. In some embodiments, the system could implement a sensor array and analysis modules to understand multimodal user inputs, including eye gaze, facial expressions, gestures, voice, or other types of input, separately or simultaneously (e.g., considering different combinations of facial expressions and voice inputs as different contexts).

The user device 210 further includes user content 214 that includes any form of content the user has viewed or otherwise consumed previously. The user content 214 may include, for example, emails, web browsing history or other information (e.g., cookies), local application data (e.g., from social media applications), instant messages (e.g., SMS text or other types of messages), images, video, sound (e.g., music), or any other content or stimuli to which the user has been exposed. The user content 214 available to be accessed by the virtual environment application and/or the topic of interest model may be limited by the user. For example, the user may choose to share all or only a portion of the user content 214 to be analyzed by the model. Although shown as being stored on the user device, the user content 214 may be stored elsewhere, e.g., at another device connected to the network 110 (e.g., in a cloud storage account associated with the user).

The topics of interest model 216 may be any suitable type of topic of interest content model. The topics of interest model 216 may use a topics of interest classifier 218 to identify and classify various topics of interest within the user content 214. As an example, the classifier 218, the model 216, or both, may include a Latent Dirichlet Allocation (LDA) model that analyzes text corpus of the user content 214 to identify topics of interest for the user. LDA may refer to a generative and probabilistic model that can be used to identify topics of interest in a text corpus. Each topic can be characterized by a distribution over words. The LDA can infer an underlying topic from a corpus by identifying the most likely topics that generated the observed documents. LDA can also be used to capture a priority as it is a probabilistic model. The model can give measures of coherence (e.g., if the topics are distinct and terms within them are highly related, LDAs can give better coherence scores), which can be a proxy for priority.

Because LDAs are meant to provide user interpretable topics, they may be well-suited for embodiments herein. However, embodiments may include other types of classifiers or models, including large language models (LLM), a BERT (Bidirectional Encoder Representations from Transformers) or BERT-based model such as BERTSUM, a Non-Negative Matrix Factorization (NMF) model, or other natural language processing (NLP) models. In some embodiment, deep neural network (DNN) transformers can be used in the model 216 as well.

As another example, the classifier 218, the model 216, or both, may include a convolutional neural network (CNN) model that is trained to recognize images, including those within video, that may be interesting to a user based on analysis of other images or of image topics like a style of painting (e.g., impressionist). CNNs can process images to extract features from raw pixel data. CNNs could be used, for example, to identify image features in a user's collection of photos (e.g., within the user content 214). CNNs can also be used with transfer learning; that is, a pre-trained CNN has already learned to extract features from a large dataset, such as ImageNet, and then it can be fine-tuned on a user's personal photos collection. In some embodiments, CNN long short-term memory (LSTM) model or a Vision Transformer (ViT)-based model may be used.

In some embodiments, the model 216 may implement a deep neural network (DNN) with both an LDA and CNN. In a virtual space enabled by a game engine, identifying both visual and textual content can be done using a combination of LDA and CNN. For instance, sample frames from the visual environment output could be analyzed for topics of interest, and multimodal techniques can be used to integrate the visual and textual information and extract higher-level features. Alternatively, they could be run separately.

To preserve metadata associated with specific content items of interest in the virtual environment, the metadata can be associated with the content. For example, a CNN can be used to identify objects in the virtual space, and associated metadata can be gathered from each object's bounding box. This metadata could include information such as the object's name, description, and relationships to other objects in the environment. Metadata could be generated by another model that performs object recognition for labelling. The metadata can then be stored in a database, either locally at the user device 210 or at the host device(s) 230. If the identified topics of interest in the environment is within text, the system can associate metadata with each text element.

The virtual space content classifier 220 can identify various topics of potential interest within the virtual environment. In some embodiments, the classifier 220 may include a similar model type as the topics of interest model 216 and/or topics of interest classifier 218. Topics of interest that are identified within the virtual environment 232 could also have meta-data to indicate a type of content or may include a priority/certainty indication for the model. The ‘priority/certainty’ indication could be used in cases where too many items of interest could overwhelm the user, while the ‘type’ indicator could be used to choose a correct system response. Some examples of these indicators are described further below, e.g., with respect to Table 1.

The system response director 224 can implement a response (e.g., a modification to the local execution of the virtual environment 226 shown on the user device 210) from a set of possible responses 222 based on the virtual space content classifier 220 identifying a topic of interest in the virtual environment 232. In some embodiments, the system response director 224 may be a rule-based artificial intelligence (AI) model.

Table 1 illustrates some example rules for a system response director 224. In the table, User 1 is the “ego” user experiencing the virtual environment implementing aspects of the present disclosure. User 2 and Speaker(s) refer to other users in the virtual environment.

TABLE 1
Example System Response Action Set

| | Topic | User | |
|---|---|---|---|
| | priority/ | behavior and | |
| Topic of | certainty/ | contextual | |
| interest type | coherence | cues | System response |
| Confidential | High | User 1 voice | System reduces audio |
| topic | | amplitude | intelligibility to users other than |
| | | lowers by x | User 1 and User 2 |
| | | percent; User | |
| | | 2 in close | |
| | | virtual | |
| | | proximity | |
| Confidential | Low | User 1 voice | System reduces audio |
| topic | | amplitude | intelligibility to users other than |
| | | lowers by x | User 1 and User 2 |
| | | percent; User | |
| | | 2 in close | |
| | | virtual | |
| | | proximity | |
| User 1 says User | High | User 1 voice | System amplifies virtual space |
| 3's name | | amplitude is | volume of User 1 utterance, |
| | | X times | differentially for User 3 |
| | | average; User | |
| | | 3 is a recent | |
| | | conversant | |
| | | with User 1; | |
| | | User 3 is high | |
| | | on User 1 | |
| | | friend list; | |
| | | User 3 is not | |
| | | close enough | |
| | | virtually to | |
| | | hear of | |
| | | background | |
| | | noise | |
| Voice input with | high | | Highlight the User 2/Speaker in |
| the first and last | | | the virtual space, convert voice |
| name of User 1 | | | to text, display the text in a box |
| | | | near User 2 in the virtual space |
| Voice input with | medium | | Highlight the User 2/Speaker in |
| the first name of | | | the virtual space with an interest |
| User 1 in it | | | icon (User 1 can click to see |
| | | | more info) |
| Topic of specific | high | | Highlight Speakers in the |
| interest to User 1 | | | virtual space, show topic title |
| detected in a | | | near Speakers in the virtual |
| conversation | | | space |
| Topic of related | low | | Queue the System Response, |
| interest to User 1 | | | thus showing it only if not |
| detected in a | | | many topics of interest are |
| conversation | | | arising |
| Topic of specific | high | User | Highlight Speaker in the virtual |
| interest to User 1 | | 2/Speaker in | space, show topic title near the |
| detected in a | | close virtual | Speaker in the virtual space; |
| conversation | | proximity | increase the voice volume of the |
| | | | Speaker |
| Visual Element 1 | high | Virtual | Highlight the location (and |
| in virtual space | | Element 1 is | arrow pointing in direction) of |
| highly matching | | not in visual | the image in the virtual space |
| features of User | | proximity to | (including show on virtual |
| 1 photos | | User 1 | space map if not in immediate |
| | | | vicinity) |

As shown in Table 1, a system response action set includes various actions that are to be taken by the system in response to a user context or behavior and/or a user topic of interest being identified. The user behavior may include, for example, a user's voice volume, tone of voice, gestures (which may refer to any user movement, including, for example, facial expressions or poses), or positions of the user with respect to sensor devices (e.g., the user's distance from their microphone or camera), etc. The user context may be based on the user's location within the environment, e.g., in a particular space, the time of day, or a vicinity within the virtual environment to other users, items, or conversations (e.g., those of potential interest).

In some embodiments, the set of system responses 222 the system response director 224 can choose from may depend on the application or on a user profile. For instance, depending on the application, some responses may not be available or allowed, e.g., if they are antithetical to the goals of the virtual environment 232. As an example, an application may allow topics but not names to trigger system responses on the user side.

In some embodiments, the system response director 224 can have one or more rules related to the responses. For example, the director 224 may include a rule related to the amount of alerts that can be shown to a user per unit of time, to avoid overwhelming the user with too many indicators. The rules may be user-configurable, in some cases.

In some embodiments, the system response director 224 can track the user's response or reaction to the response selected from the set of system responses 222, and adjust accordingly. For example, if the user has ignored system responses to certain topics, the director 224 could apply lower priorities to that topic when discovered by the classifier 220. The user's attention to topics and system responses could be monitored, for example, via mouse click rates, gaze tracking, or other mechanisms.

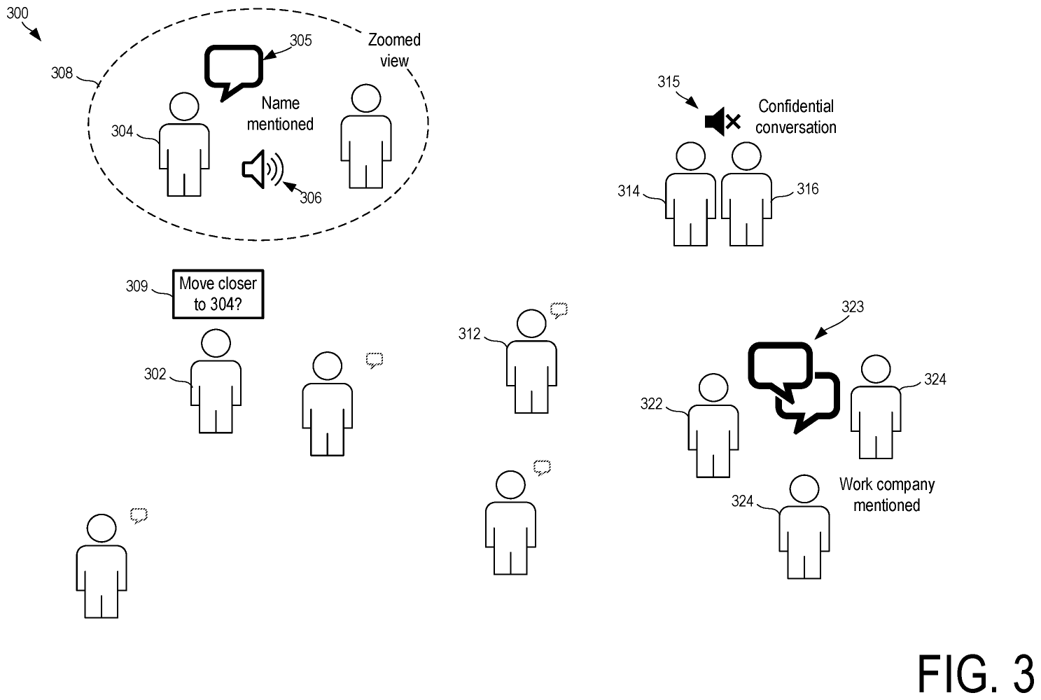

FIG. 3 illustrates aspects of an example virtual environment 300 being modified based on user behavior or context in accordance with embodiments of the present disclosure. In the example environment shown, each avatar may be a visual representation of a user of the virtual environment, e.g., a user of a user device as described above. For instance, avatar 302 may be some visual representation of a first user interacting with the virtual environment, avatar 304 may be some visual representation of a second user interacting with the virtual environment, and so forth. The virtual environment may be generated by one or more host computing devices (e.g., those at host 102 of FIG. 1) based on inputs from the users via their user devices (e.g., 104, 106, 108 of FIG. 1). The virtual environment may provide a two-dimensional or three-dimensional space in which the users of the user devices may interact with one another, e.g., via text data, voice/audio data, image/video data, or other means. One or more of the modifications described below may be displayed at the views generated by the local executions of the environment running on the user devices. In some cases, as will be readily apparent from the examples below and other descriptions herein, only certain modifications in accordance with the teachings of the present disclosure may be displayed to certain users.

In a first example, the user represented by avatar 304 mentions the name of the user represented by avatar 302. Though the user represented by avatar 302 is not within what is considered to be a “hearing distance” (e.g., a distance in which the user might normally be able to hear users talking or messaging within the environment), one or more modifications may be made to the virtual environment presented to the user represented by avatar 302 on their respective user device. For example, in some embodiments, a visual indication such as a chat bubble 305 (e.g., where interactions are through voice chat, or by highlighting, bolding, or otherwise emphasizing an existing chat bubble where interactions between users are through text-based messaging) may be displayed to call attention to the user represented by avatar 302, in a similar way that the user might be able to overhear another person using their name via the cocktail party effect. Further to that point, in some embodiments, the volume of the conversation between the user represented by avatar 304 and another user may be amplified (represented in FIG. 3 by the volume icon 306) to allow the user represented by avatar 302 to better hear the conversation in the environment, or the volume of other users in the environment may be lowered with respect to the conversation involving the user represented by avatar 304. In addition, in some embodiments, the user represented by avatar 302 may be further called to attention of the mention of their name through a zooming in to the area around the user represented by avatar 304. In other embodiments, the location of the user's avatar may be moved closer to the conversation of interest, e.g., in response to a prompt such as prompt 309 presented to the user. As will be appreciated, any of these modifications may only be made to the environment presented to the user represented by avatar 302, since they are related to a topic of interest for that user (i.e., their name) as opposed to other users (e.g., the user represented by avatar 312).

In another example, a user represented by avatar 312 may have called to their attention a conversation between the users 322, 324, 326 where one or multiple of the users mention the place of work (“work company”) of the user represented by avatar 312. Similar to the above example, a chat bubble 323 may be shown, or the conversation may be highlighted in some other manner (e.g., volume increase).

In yet another example, a conversation user represented by avatar 314 and user represented by avatar 316 are determined by the environment to be having a confidential conversation. This determination may be made by a number of factors, including keywords (e.g., confidential project names, or other words used that are associated with confidential conversations one or both of the users had in their data sets), relative proximity to each other or changes in proximity (e.g., coming closer together in the environment before speaking certain phrases), gestures (e.g., covering a mouth when speaking), changes in tone or volume (e.g., lowering the volume or tone of voice to speak certain phrases), or by other means. As such, the environment may mute this conversation or lower the volume of the conversation in environments presented to other users (e.g., the users represented by avatars 302, 304, etc., represented by the mute sign 315 in FIG. 3).

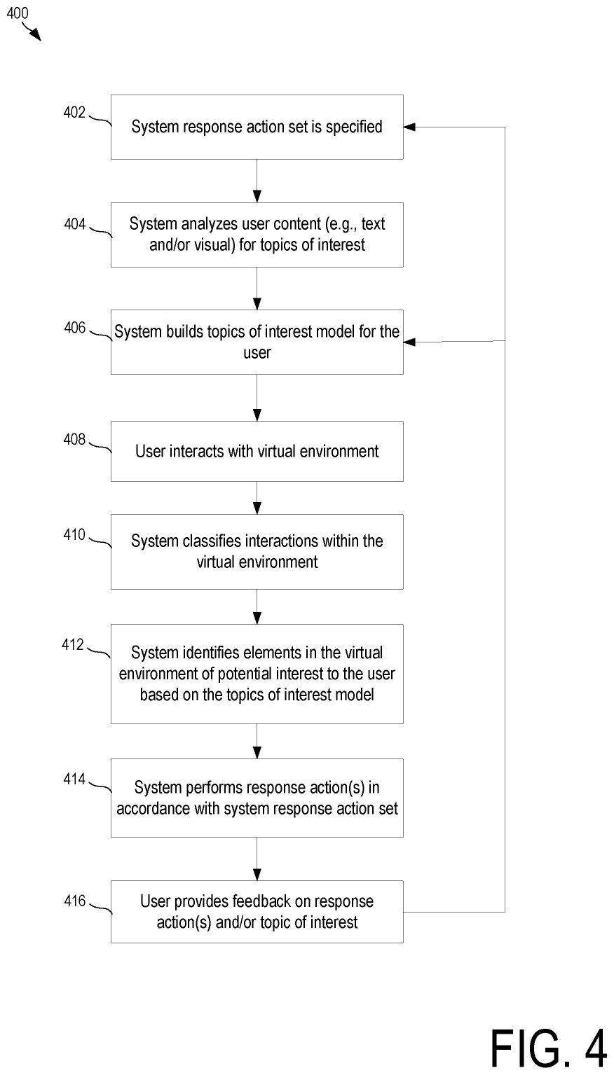

FIG. 4 illustrates a flow diagram of an example process 400 of modifying a virtual environment based on user behavior or context in accordance with embodiments of the present disclosure. Operations of the process 400 may be implemented by various portions of a virtual environment, e.g., by a host device or system for the environment (e.g., 102 of FIG. 1), by a user device connected to the host (e.g., 104, 106, 108 of FIG. 1), or by a combination thereof. As used below, “system” may refer to the host, a user device or user device(s), or a combination thereof, depending on the implementation of the virtual environment.

The process may include additional, fewer, or different operations than those shown or described below. Moreover, one or more of the operations shown include multiple operations, sub-operations, etc. Particular embodiments may encode instructions in one or more computer-readable media that, when executed, implement the operations of the process shown and described below. For example, a computer program product may include a set of instructions that, when executed by one or more processors, cause the processor(s) to perform the operations shown in FIG. 4 or described further below.

At 402, a system response action set is specified for the virtual environment. This may be done at a host for the environment (e.g., 102), in certain embodiments. In some embodiments, the host system may set a global or default response action set. Further, in some embodiments, user devices (e.g., 104, 106, 108) may be able to customize or otherwise modify the action set for implementation in their respective execution of the virtual environment (e.g., 226). The system response action set may include a number of system actions to be performed (e.g., modifications to the environment displayed to a user) in response to various triggers, e.g., e.g., a combination of a topic of interest being identified along with a particular user context in the environment or user behavior. In some embodiments, a response action may refer to an action the system takes when it determines that the user should have feedback to indicate where or how something of potential interest to the user happened or is happening in the virtual environment. Table 1 above illustrates an example system response action set that may be specified for a virtual environment, but other response actions may be specified than those shown in Table 1.

At 404, the system analyzes user content (e.g., 214), which may be on the user device (e.g., 104) or stored elsewhere (e.g., in the cloud), to identify topics of interest. In some embodiments, this may be performed by the user device locally, or may be performed by the host system with a copy or subset of the user content of the user device. In some instances, a portion of this operation may be performed by the user device, and information may be sent to the host device for identification or classification of the topics of interest.

At 406, the system builds a topics of interest model (e.g., 216) for the user. The topics of interest model may be built locally on the user device, or by the host system based on information sent by the user device. The model may be constructed as described in detail above. At 408, the user interacts with the virtual environment, and at 410, the system classifies interactions with the virtual environment (e.g., using 220). This may include audio, visual, or textual interactions with the virtual environment by the user or other users in the virtual environment. For instance, the system may classify utterances or messages of users as being related to one or more topics. At 412, the system identifies elements (e.g., audio, visual, or textual) in the virtual environment that may be of interest to the user using the topics of interest model generated at 406. For instance, the system can identify whether the classifications that were made at 410 are related to a topic of interest for the user in their topics of interest model generated at 406.

At 414, the system performs one or more response actions in accordance with the system response action set specified at 402. The response action(s) taken may be based on the identification of a topic of interest at 412, and may also be taken additionally based on a user context or behavior. For instance, many people in the environment may be discussing topics of interest to a user, but only certain of the discussions may be called to the user's attention based on a context of the user, e.g., a location of the user within the virtual environment, including the vicinity of the user to the discussions, or an orientation of the user with respect to the discussion (e.g., whether the user is facing toward or away from the discussion). In addition, the response action(s) taken may be based on a priority indicated in the response action set. For instance, system responses indicated to have high priority may be immediately taken or may have a different action to be taken versus a system response for the same topic or user context indicated to have a lower priority. As an example, a high priority response action may be to both highlight another user mentioning a user's name and call attention to the utterance with a chat bubble versus just highlighting the name uttering user for a lower priority response action.

At 416, the user may provide feedback to the system related to the response action(s) taken at 414 or the topic(s) of interest the response actions were based on. For example, a user may choose to turn off response actions for a particular topic of interest, lower a priority of response actions for a particular topic of interest, snooze actions for a particular topic of interest, etc. Further, the user may choose to edit or remove a particular response action. For example, a user may choose to modify a response action of both highlighting a user and indicating a chat bubble to only one of the two actions or may choose to remove the particular response action altogether. Based on the user feedback, the system may accordingly adjust the system response action set or the topics of interest model.

### Example Computing Systems

FIG. 5 illustrates a simplified block diagram of a computing device in which aspects of the present disclosure may be incorporated. The computing device 500 for selective updating of a display is shown. In use, the illustrative computing device 500 determines one or more regions of a display to be updated. For example, a user may move a cursor and a clock may change from one frame to the next, requiring an update to two regions of a display. The computing device 500 sends update regions from a source to a sink in the display 518 over a link. In the illustrative embodiment, the source does not have direct access to the link port while the sink does have direct access to the link port. The source can send an indication that a particular update message is the last message to be sent for the current frame, after which the source will be entering an idle period without sending update messages. The sink can then place the link in a low-power state to reduce power usage.

The computing device 500 may be embodied as any type of computing device. For example, the computing device 500 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, and/or any other computing device. In some embodiments, the computing device 500 may be located in a data center, such as an enterprise data center (e.g., a data center owned and operated by a company and typically located on company premises), managed services data center (e.g., a data center managed by a third party on behalf of a company), a co-located data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

The illustrative computing device 500 includes a processor 502, a memory 504, an input/output (I/O) subsystem 506, data storage 508, a communication circuit 510, a graphics processing unit 512, a camera 514, a microphone 516, a display 518, and one or more peripheral devices 520. In some embodiments, one or more of the illustrative components of the computing device 500 may be incorporated in, or otherwise form a portion of, another component. For example, the memory 504, or portions thereof, may be incorporated in the processor 502 in some embodiments. In some embodiments, one or more of the illustrative components may be physically separated from another component.

The processor 502 may be embodied as any type of processor capable of performing the functions described herein. For example, the processor 502 may be embodied as a single or multi-core processor(s), a single or multi-socket processor, a digital signal processor, a graphics processor, a neural network compute engine, an image processor, a microcontroller, or other processor or processing/controlling circuit. Similarly, the memory 504 may be embodied as any type of volatile or non-volatile memory or data storage capable of performing the functions described herein. In operation, the memory 504 may store various data and software used during operation of the computing device 500 such as operating systems, applications, programs, libraries, and drivers. The memory 504 is communicatively coupled to the processor 502 via the I/O subsystem 506, which may be embodied as circuitry and/or components to facilitate input/output operations with the processor 502, the memory 504, and other components of the computing device 500. For example, the I/O subsystem 506 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. The I/O subsystem 506 may connect various internal and external components of the computing device 500 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 506 may form a portion of a system-on-a-chip (SoC) and be incorporated, along with the processor 502, the memory 504, and other components of the computing device 500 on a single integrated circuit chip.

The data storage 508 may be embodied as any type of device or devices configured for the short-term or long-term storage of data. For example, the data storage 508 may include any one or more memory devices and circuits, memory cards, hard disk drives, solid-state drives, or other data storage devices.

The communication circuit 510 may be embodied as any type of interface capable of interfacing the computing device 500 with other computing devices, such as over one or more wired or wireless connections. In some embodiments, the communication circuit 510 may be capable of interfacing with any appropriate cable type, such as an electrical cable or an optical cable. The communication circuit 510 may be configured to use any one or more communication technology and associated protocols (e.g., Ethernet, Bluetooth®, Wi-Fi®, WiMAX, near field communication (NFC), etc.). The communication circuit 510 may be located on silicon separate from the processor 502, or the communication circuit 510 may be included in a multi-chip package with the processor 502, or even on the same die as the processor 502. The communication circuit 510 may be embodied as one or more add-in-boards, daughtercards, network interface cards, controller chips, chipsets, specialized components such as a field-programmable gate array (FPGA) or application-specific integrated circuit (ASIC), or other devices that may be used by the computing device 500 to connect with another computing device. In some embodiments, communication circuit 510 may be embodied as part of a system-on-a-chip (SoC) that includes one or more processors or included on a multichip package that also contains one or more processors. In some embodiments, the communication circuit 510 may include a local processor (not shown) and/or a local memory (not shown) that are both local to the communication circuit 510. In such embodiments, the local processor of the communication circuit 510 may be capable of performing one or more of the functions of the processor 502 described herein. Additionally or alternatively, in such embodiments, the local memory of the communication circuit 510 may be integrated into one or more components of the computing device 500 at the board level, socket level, chip level, and/or other levels.

The graphics processing unit 512 is configured to perform certain computing tasks, such as video or graphics processing. The graphics processing unit 512 may be embodied as one or more processors, data processing unit, field-programmable gate arrays (FPGAs), application-specific integrated circuits (ASICs), and/or any combination of the above. In some embodiments, the graphics processing unit 512 may send frames or partial update regions to the display 518. For instance, the example graphics processing unit 512 includes a display engine 513, which may be embodied as hardware, firmware, software, virtualized hardware, emulated architecture, and/or a combination thereof, and is configured to determine frames to be sent to the display 518 and send the images to the display 518. In the illustrative embodiment, the display engine 513 is part of the graphics processing unit 512. In other embodiments, the display engine 513 may be part of the processor 502 or other component of the device 500.

In certain embodiments, the display engine 513 may include circuitry to implement aspects of the present disclosure, e.g., circuitry to implement the computational aspects described with respect to FIG. 1 above. For example, the display engine 513 may access frames stored in the memory 504, enhance the frames as described above, and then stream the frames to the display 518.

The camera 514 may include one or more fixed or adjustable lenses and one or more image sensors. The image sensors may be any suitable type of image sensors, such as a CMOS or CCD image sensor. The camera 514 may have any suitable aperture, focal length, field of view, etc. For example, the camera 514 may have a field of view of 60-110° in the azimuthal and/or elevation directions.

The microphone 516 is configured to sense sound waves and output an electrical signal indicative of the sound waves. In the illustrative embodiment, the computing device 500 may have more than one microphone 516, such as an array of microphones 516 in different positions.

The display 518 may be embodied as any type of display on which information may be displayed to a user of the computing device 500, such as a touchscreen display, a liquid crystal display (LCD), a thin film transistor LCD (TFT-LCD), a light-emitting diode (LED) display, an organic light-emitting diode (OLED) display, a cathode ray tube (CRT) display, a plasma display, an image projector (e.g., 2D or 3D), a laser projector, a heads-up display, and/or other display technology. The display 518 may have any suitable resolution, such as 7680×4320, 3840×2160, 1920×1200, 1920×1080, etc.

The display 518 includes a timing controller (TCON) 519, which includes circuitry to convert video data received from the graphics processing unit 512 into signals that drive a panel of the display 518. In some embodiments, the TCON 519 may also include circuitry to implement one or more aspects of the present disclosure. For example, the TCON 519 may include circuitry to implement the computational aspects described with respect to FIG. 1 above. For example, the TCON 519 may enhance frames received from the graphics processing unit 512 and stream the frames to the panel of the display 518.

In some embodiments, the computing device 500 may include other or additional components, such as those commonly found in a computing device. For example, the computing device 500 may also have peripheral devices 520, such as a keyboard, a mouse, a speaker, an external storage device, etc. In some embodiments, the computing device 500 may be connected to a dock that can interface with various devices, including peripheral devices 520. In some embodiments, the peripheral devices 520 may include additional sensors that the computing device 500 can use to monitor the video conference, such as a time-of-flight sensor or a millimeter-wave sensor.

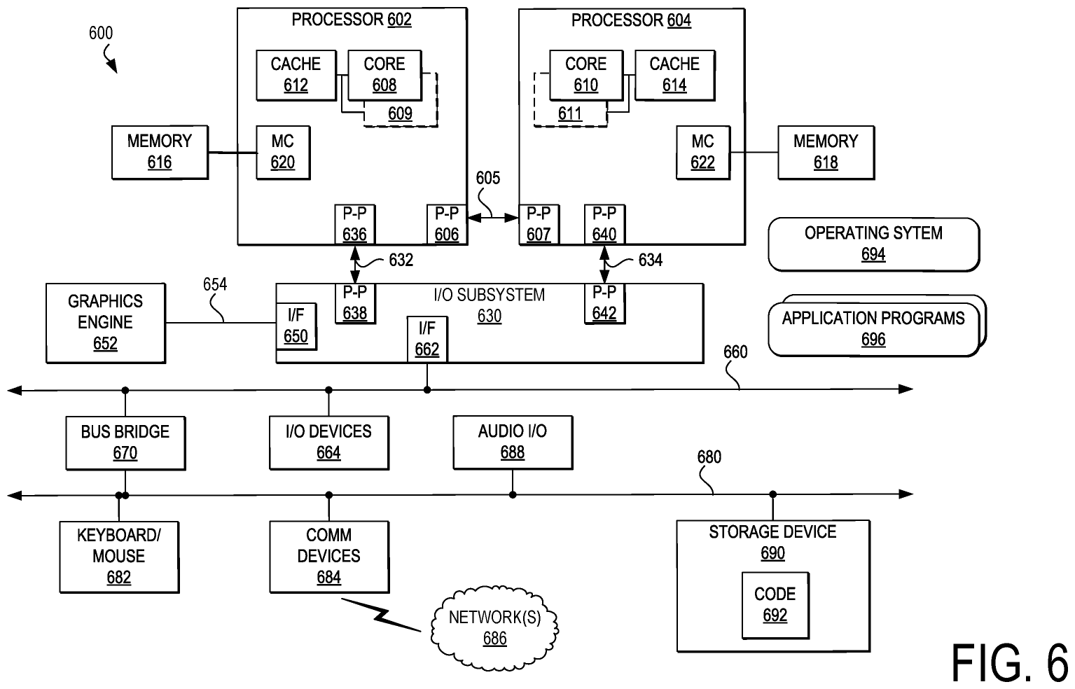

FIG. 6 is a block diagram of computing device components which may be included in a mobile computing device incorporating aspects of the present disclosure. In some embodiments, the components shown may be implemented within the devices shown in FIG. 1 (e.g., in the host devices 102 and/or user devices 104, 106, 108). Generally, components shown in FIG. 6 can communicate with other shown components, although not all connections are shown, for ease of illustration. The components 600 comprise a multiprocessor system comprising a first processor 602 and a second processor 604 and is illustrated as comprising point-to-point (P-P) interconnects. For example, a point-to-point (P-P) interface 606 of the processor 602 is coupled to a point-to-point interface 607 of the processor 604 via a point-to-point interconnection 605. It is to be understood that any or all of the point-to-point interconnects illustrated in FIG. 6 can be alternatively implemented as a multi-drop bus, and that any or all buses illustrated in FIG. 6 could be replaced by point-to-point interconnects.

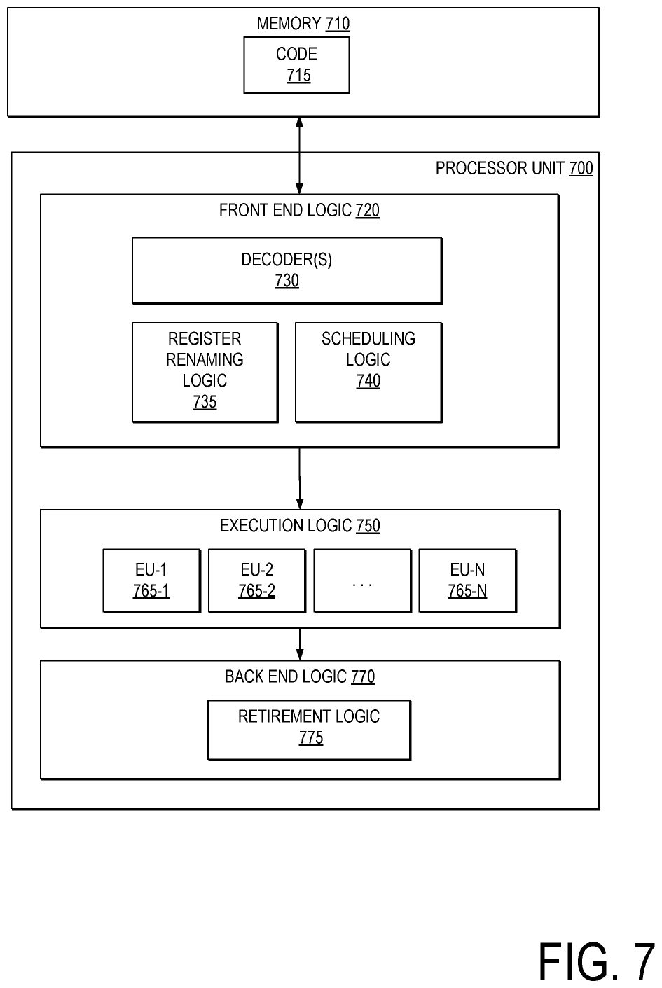

As shown in FIG. 6, the processors 602 and 604 are multicore processors. Processor 602 comprises processor cores 608 and 609, and processor 604 comprises processor cores 610 and 611. Processor cores 608-611 can execute computer-executable instructions in a manner similar to that discussed below in connection with FIG. 7, or in other manners.

Processors 602 and 604 further comprise at least one shared cache memory 612 and 614, respectively. The shared caches 612 and 614 can store data (e.g., instructions) utilized by one or more components of the processor, such as the processor cores 608-609 and 610-611. The shared caches 612 and 614 can be part of a memory hierarchy for the device. For example, the shared cache 612 can locally store data that is also stored in a memory 616 to allow for faster access to the data by components of the processor 602. In some embodiments, the shared caches 612 and 614 can comprise multiple cache layers, such as level 1 (L1), level 2 (L2), level 3 (L3), level 4 (L4), and/or other caches or cache layers, such as a last level cache (LLC).

Although two processors are shown, the device can comprise any number of processors or other compute resources. Further, a processor can comprise any number of processor cores. A processor can take various forms such as a central processing unit, a controller, a graphics processor, an accelerator (such as a graphics accelerator, digital signal processor (DSP), or artificial intelligence (AI) accelerator)). A processor in a device can be the same as or different from other processors in the device. In some embodiments, the device can comprise one or more processors that are heterogeneous or asymmetric to a first processor, accelerator, field programmable gate array (FPGA), or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 602 and 604 reside in a multi-chip package. As used herein, the terms “processor unit” and “processing unit” can refer to any processor, processor core, component, module, engine, circuitry or any other processing element described herein. A processor unit or processing unit can be implemented in hardware, software, firmware, or any combination thereof capable of.

Processors 602 and 604 further comprise memory controller logic (MC) 620 and 622. As shown in FIG. 6, MCs 620 and 622 control memories 616 and 618 coupled to the processors 602 and 604, respectively. The memories 616 and 618 can comprise various types of memories, such as volatile memory (e.g., dynamic random-access memories (DRAM), static random-access memory (SRAM)) or non-volatile memory (e.g., flash memory, solid-state drives, chalcogenide-based phase-change non-volatile memories). While MCs 620 and 622 are illustrated as being integrated into the processors 602 and 604, in alternative embodiments, the MCs can be logic external to a processor, and can comprise one or more layers of a memory hierarchy.

Processors 602 and 604 are coupled to an Input/Output (I/O) subsystem 630 via P-P interconnections 632 and 634. The point-to-point interconnection 632 connects a point-to-point interface 636 of the processor 602 with a point-to-point interface 638 of the I/O subsystem 630, and the point-to-point interconnection 634 connects a point-to-point interface 640 of the processor 604 with a point-to-point interface 642 of the I/O subsystem 630. Input/Output subsystem 630 further includes an interface 650 to couple I/O subsystem 630 to a graphics module 652, which can be a high-performance graphics module. The I/O subsystem 630 and the graphics module 652 are coupled via a bus 654. Alternately, the bus 654 could be a point-to-point interconnection.

Input/Output subsystem 630 is further coupled to a first bus 660 via an interface 662. The first bus 660 can be a Peripheral Component Interconnect (PCI) bus, a PCI Express (PCIe) bus, another third generation I/O (input/output) interconnection bus or any other type of bus.

Various I/O devices 664 can be coupled to the first bus 660. A bus bridge 670 can couple the first bus 660 to a second bus 680. In some embodiments, the second bus 680 can be a low pin count (LPC) bus. Various devices can be coupled to the second bus 680 including, for example, a keyboard/mouse 682, audio I/O devices 688 and a storage device 690, such as a hard disk drive, solid-state drive or other storage device for storing computer-executable instructions (code) 692. The code 692 can comprise computer-executable instructions for performing technologies described herein. Additional components that can be coupled to the second bus 680 include communication device(s) or components 684, which can provide for communication between the device and one or more wired or wireless networks 686 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

The device can comprise removable memory such as flash memory cards (e.g., SD (Secure Digital) cards), memory sticks, Subscriber Identity Module (SIM) cards). The memory in the computing device (including caches 612 and 614, memories 616 and 618 and storage device 690) can store data and/or computer-executable instructions for executing an operating system 694, or application programs 696. Example data includes web pages, text messages, images, sound files, video data, sensor data, or other data sets to be sent to and/or received from one or more network servers or other devices by the device via one or more wired or wireless networks, or for use by the device. The device can also have access to external memory (not shown) such as external hard drives or cloud-based storage.

The operating system 694 can control the allocation and usage of the components illustrated in FIG. 6 and support one or more application programs 696. The application programs 696 can include common mobile computing device applications (e.g., email applications, calendars, contact managers, web browsers, messaging applications) as well as other computing applications.

The device can support various input devices, such as a touchscreen, microphones, cameras (monoscopic or stereoscopic), trackball, touchpad, trackpad, mouse, keyboard, proximity sensor, light sensor, pressure sensor, infrared sensor, electrocardiogram (ECG) sensor, PPG (photoplethysmogram) sensor, galvanic skin response sensor, and one or more output devices, such as one or more speakers or displays. Any of the input or output devices can be internal to, external to or removably attachable with the device. External input and output devices can communicate with the device via wired or wireless connections.

In addition, the computing device can provide one or more natural user interfaces (NUIs). For example, the operating system 694 or application programs 696 can comprise speech recognition as part of a voice user interface that allows a user to operate the device via voice commands. Further, the device can comprise input devices and components that allows a user to interact with the device via body, hand, or face gestures.

The device can further comprise one or more communication components 684. The components 684 can comprise wireless communication components coupled to one or more antennas to support communication between the device and external devices. Antennas can be located in a base, lid, or other portion of the device. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device can further include at least one input/output port (which can be, for example, a USB, IEEE 1394 (FireWire), Ethernet and/or RS-232 port) comprising physical connectors; a power supply (such as a rechargeable battery); a satellite navigation system receiver, such as a GPS receiver; a gyroscope; an accelerometer; and a compass. A GPS receiver can be coupled to a GPS antenna. The device can further include one or more additional antennas coupled to one or more additional receivers, transmitters and/or transceivers to enable additional functions.

FIG. 6 illustrates one example computing device architecture. Computing devices based on alternative architectures can be used to implement technologies described herein. For example, instead of the processors 602 and 604, and the graphics module 652 being located on discrete integrated circuits, a computing device can comprise a SoC (system-on-a-chip) integrated circuit incorporating one or more of the components illustrated in FIG. 6. In one example, an SoC can comprise multiple processor cores, cache memory, a display driver, a GPU, multiple I/O controllers, an AI accelerator, an image processing unit driver, I/O controllers, an AI accelerator, an image processor unit. Further, a computing device can connect elements via bus or point-to-point configurations different from that shown in FIG. 6. Moreover, the illustrated components in FIG. 6 are not required or all-inclusive, as shown components can be removed and other components added in alternative embodiments.

FIG. 7 is a block diagram of an example processor unit 700 to execute computer-executable instructions. The processor unit 700 can be any type of processor or processor core, such as a microprocessor, an embedded processor, a digital signal processor (DSP), network processor, or accelerator. The processor unit 700 can be a single-threaded core or a multithreaded core in that it may include more than one hardware thread context (or “logical processor”) per core.

FIG. 7 also illustrates a memory 710 coupled to the processor 700. The memory 710 can be any memory described herein or any other memory known to those of skill in the art. The memory 710 can store computer-executable instructions 715 (code) executable by the processor unit 700.

The processor core comprises front-end logic 720 that receives instructions from the memory 710. An instruction can be processed by one or more decoders 730. The decoder 730 can generate as its output a micro operation such as a fixed width micro operation in a predefined format, or generate other instructions, microinstructions, or control signals, which reflect the original code instruction. The front-end logic 720 further comprises register renaming logic 735 and scheduling logic 740, which generally allocate resources and queues operations corresponding to converting an instruction for execution.

The processor unit 700 further comprises execution logic 750, which comprises one or more execution units (EUs) 765-1 through 765-N. Some processor core embodiments can include a number of execution units dedicated to specific functions or sets of functions. Other embodiments can include only one execution unit or one execution unit that can perform a particular function. The execution logic 750 performs the operations specified by code instructions. After completion of execution of the operations specified by the code instructions, back end logic 770 retires instructions using retirement logic 775. In some embodiments, the processor unit 700 allows out of order execution but requires in-order retirement of instructions. Retirement logic 775 can take a variety of forms as known to those of skill in the art (e.g., re-order buffers or the like).

The processor unit 700 is transformed during execution of instructions, at least in terms of the output generated by the decoder 730, hardware registers and tables utilized by the register renaming logic 735, and any registers (not shown) modified by the execution logic 750. Although not illustrated in FIG. 7, a processor can include other elements on an integrated chip with the processor unit 700. For example, a processor may include additional elements such as memory control logic, one or more graphics modules, I/O control logic modules and/or one or more caches.

As used in any embodiment herein, the term “module” refers to logic that may be implemented in a hardware component or device, software or firmware running on a processor, or a combination thereof, to perform one or more operations consistent with the present disclosure. Software may be embodied as a software package, code, instructions, instruction sets and/or data recorded on non-transitory computer-readable storage mediums. Firmware may be embodied as code, instructions or instruction sets and/or data that are hard-coded (e.g., nonvolatile) in memory devices. As used in any embodiment herein, the term “circuitry” can comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms a part of one or more devices. Thus, any of the modules can be implemented as circuitry, such as continuous itemset generation circuitry, entropy-based discretization circuitry, etc. A computer device referred to as being programmed to perform a method can be programmed to perform the method via software, hardware, firmware or combinations thereof.

The use of reference numbers in the claims and the specification is meant as in aid in understanding the claims and the specification and is not meant to be limiting.

Any of the disclosed methods can be implemented as computer-executable instructions or a computer program product. Such instructions can cause a computer or one or more processors capable of executing computer-executable instructions to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible or non-transitory computer-readable storage media, such as optical media discs (e.g., DVDs, CDs), volatile memory components (e.g., DRAM, SRAM), or non-volatile memory components (e.g., flash memory, solid state drives, chalcogenide-based phase-change non-volatile memories). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be read and executed by, for example, a single computing device or in a network environment using one or more networked computers. Further, it is to be understood that the disclosed technology is not limited to any specific computer language or program. For instance, the disclosed technologies can be implemented by software written in C++, Java, Perl, Python, JavaScript, Adobe Flash, or any other suitable programming language. Likewise, the disclosed technologies are not limited to any particular computer or type of hardware.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items joined by the term “and/or” can mean any combination of the listed items. For example, the phrase “A, B and/or C” can mean A; B; C; A and B; A and C; B and C; or A, B, and C. Further, as used in this application and in the claims, a list of items joined by the term “at least one of” can mean any combination of the listed terms. For example, the phrase “at least one of A, B, or C” can mean A; B; C; A and B; A and C; B and C; or A, B, and C. Moreover, as used in this application and in the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Certain non-limiting examples of the presently described techniques are provided below. Each of the following non-limiting examples may stand on its own or may be combined in any permutation or combination with any one or more of the other examples provided below or throughout the present disclosure.

Example 1 includes one or more computer-readable storage media comprising instructions that when executed by processing circuitry cause the processing circuitry to: instantiate a virtual environment comprising a virtual two-dimensional or three-dimensional space in which a plurality of users can interact; classify interactions by the plurality of users within the virtual environment; identify a topic of interest for a particular user in the classified interactions based on a topics of interest model for the particular user; and cause a response action to be initiated in a local execution of the virtual environment presented to the particular user based on the identified topic of interest.

Example 2 includes the subject matter of Example 1, wherein the instructions are further to cause the response action to be initiated based on a context of the particular user in the virtual environment.

Example 3 includes the subject matter of Example 2, wherein the context of the particular user includes one or more of a location of the particular user within the virtual environment, a vicinity of the particular user with respect to other users within the virtual environment, or an orientation of the particular user within the virtual environment.

Example 4 includes the subject matter of any one of Examples 1-3, wherein the instructions are further to cause the response action to be initiated based on a behavior of the particular user.

Example 5 includes the subject matter of Example 4, wherein the behavior of the particular user includes one or more of a volume of the particular user's voice, a gesture made by the particular user, or a position of the user with respect to a sensor of a device instantiating the local execution of the virtual environment that is presented to the particular user.

Example 6 includes the subject matter of any one of Examples 1-5, wherein the instructions are further to cause the response action to be initiated based on a priority indication for the identified topic of interest.

Example 7 includes the subject matter of any one of Examples 1-6, wherein the instructions are further to select the response action to be initiated from a set of response actions.

Example 8 includes the subject matter of any one of Examples 1-7, wherein the instructions are to classify interaction or identify topics of interest using one of a Latent Dirichlet Allocation (LDA), a large language model (LLM), a natural language processing (NLP) model, and a non-negative matrix factorization (NMF) model.

Example 9 includes the subject matter of any one of Examples 1-8, wherein the instructions are to classify interaction or identify topics of interest using a convolutional neural network (CNN) model, a CNN long short-term memory (LTSM) model, or a Vision Transformer (ViT)-based model.

Example 10 includes the subject matter of any one of Examples 1-9, wherein the response action includes modifying a visual aspect of the virtual environment presented to the particular user.

Example 11 includes the subject matter of Example 10, wherein the response action includes reorienting a display of the virtual environment presented to the particular user.

Example 12 includes the subject matter of any one of Examples 1-11, wherein the response action includes modifying audio in the virtual environment presented to the particular user.

Example 13 includes the subject matter of any one of Examples 1-12, wherein the instructions are further to obtain feedback from the user related to the initiated response action and modify a set of system response actions based on the feedback.

Example 14 includes the subject matter of any one of Examples 1-13, wherein the instructions are further to generate the topics of interest model based on audio, visual, or textual content associated with the particular user.

Example 15 includes the subject matter of Example 14, wherein the audio, visual, or textual content associated with the particular user is stored on a device instantiating the local execution of the virtual environment presented to the particular user.

Example 16 is a method comprising: instantiating a virtual environment comprising a virtual two-dimensional or three-dimensional space in which a plurality of users can interact; classifying interactions by the plurality of users within the virtual environment; identifying a topic of interest for a particular user in the classified interactions based on a topics of interest model for the particular user; and initiating a response action at a local execution of the virtual environment presented to the particular user based on the identified topic of interest.

Example 17 includes the subject matter of Example 16, wherein the response action is initiated based on a context of the particular user in the virtual environment.

Example 18 includes the subject matter of Example 17, wherein the context of the particular user includes one or more of a location of the particular user within the virtual environment, a vicinity of the particular user with respect to other users within the virtual environment, or an orientation of the particular user within the virtual environment.

Example 19 includes the subject matter of any one of Examples 16-18, wherein the response action is initiated based on a behavior of the particular user.

Example 20 includes the subject matter of Example 19, wherein the behavior of the particular user includes one or more of a volume of the particular user's voice, a gesture made by the particular user, or a position of the user with respect to a sensor of a device instantiating the local execution of the virtual environment that is presented to the particular user.

Example 21 includes the subject matter of any one of Examples 16-20, wherein the response action is initiated based on a priority indication for the identified topic of interest.

Example 22 includes the subject matter of any one of Examples 16-21, wherein the initiated response action is selected from a set of response actions.

Example 23 includes the subject matter of any one of Examples 16-22, wherein classifying interaction or identifying topics of interest is based on using one of a Latent Dirichlet Allocation (LDA), a large language model (LLM), a natural language processing (NLP) model, and a non-negative matrix factorization (NMF) model.

Example 24 includes the subject matter of any one of Examples 16-23, wherein classifying interaction or identifying topics of interest is based on using a convolutional neural network (CNN) model, a CNN long short-term memory (LTSM) model, or a Vision Transformer (ViT)-based model.

Example 25 includes the subject matter of any one of Examples 16-24, wherein the response action includes modifying a visual aspect of the virtual environment presented to the particular user.

Example 26 includes the subject matter of Example 25, wherein the response action includes reorienting a display of the virtual environment presented to the particular user.

Example 27 includes the subject matter of any one of Examples 16-26, wherein the response action includes modifying audio in the virtual environment presented to the particular user.

Example 28 includes the subject matter of any one of Examples 16-27, further comprising receiving feedback from the user related to the initiated response action and modifying a set of system response actions based on the feedback.

Example 29 includes the subject matter of any one of Examples 16-28, further comprising generating the topics of interest model based on audio, visual, or textual content associated with the particular user.

Example 30 includes the subject matter of Example 29, wherein the audio, visual, or textual content associated with the particular user is stored on a device instantiating the local execution of the virtual environment presented to the particular user.

Example 31 is an apparatus comprising circuitry to implement the method of any one of Examples 16-30, or to implement any of the other aspects described herein.

Example 32 is a computing system comprising circuitry to implement the apparatus of Example 31 or to implement the method of any one of Examples 16-30, or to implement any of the other aspects described herein.

Example 33 is a system comprising: one or more host computing devices to instantiate a virtual environment comprising a virtual two-dimensional or three-dimensional space in which a plurality of users can interact; and a plurality of user devices connected to the one or more host computing devices over a network, each user device to instantiate a local execution of the virtual environment; wherein the host computing devices, the user device, or both, are to: classify interactions by the plurality of users within the virtual environment; identify a topic of interest for a particular user in the classified interactions based on a topics of interest model for the particular user; and cause a response action to be initiated in the local execution of the virtual environment presented to the particular user based on the identified topic of interest.

Example 34 includes the subject matter of Example 33, wherein each user device is to cause the response action to be initiated based on a context of the particular user in the virtual environment.

Example 35 includes the subject matter of Example 34, wherein the context of the particular user includes one or more of a location of the particular user within the virtual environment, a vicinity of the particular user with respect to other users within the virtual environment, or an orientation of the particular user within the virtual environment.

Example 36 includes the subject matter of any one of Examples 33-35, wherein each user device is to cause the response action to be initiated based on a behavior of the particular user.

Example 37 includes the subject matter of Example 36, wherein the behavior of the particular user includes one or more of a volume of the particular user's voice, a gesture made by the particular user, or a position of the user with respect to a sensor of a device instantiating the local execution of the virtual environment that is presented to the particular user.

Example 38 includes the subject matter of any one of Examples 33-27, wherein each user device is to cause the response action to be initiated based on a priority indication for the identified topic of interest.

Example 39 includes the subject matter of any one of Examples 33-38, wherein each user device is to select the response action to be initiated from a set of response actions.

Example 40 includes the subject matter of any one of Examples 33-39, wherein each user device is to classify interaction or identify topics of interest using one of a Latent Dirichlet Allocation (LDA), a large language model (LLM), a natural language processing (NLP) model, and a non-negative matrix factorization (NMF) model.

Example 41 includes the subject matter of any one of Examples 33-40, wherein each user device is to classify interaction or identify topics of interest using a convolutional neural network (CNN) model, a CNN long short-term memory (LTSM) model, or a Vision Transformer (ViT)-based model.

Example 43 includes the subject matter of any one of Examples 33-41, wherein the response action includes modifying a visual aspect of the virtual environment presented to the particular user.

Example 43 includes the subject matter of Example 42, wherein the response action includes reorienting a display of the virtual environment presented to the particular user.

Example 44 includes the subject matter of any one of Examples 33-43, wherein the response action includes modifying audio in the virtual environment presented to the particular user.

Example 45 includes the subject matter of any one of Examples 33-44, wherein each user device is to obtain feedback from the user related to the initiated response action and modify a set of system response actions based on the feedback.

Example 46 includes the subject matter of any one of Examples 33-45, wherein each user device is to generate the topics of interest model based on audio, visual, or textual content associated with the particular user.

Example 47 includes the subject matter of Example 46, wherein the audio, visual, or textual content associated with the particular user is stored on a device instantiating the local execution of the virtual environment presented to the particular user.

Example 48 includes the subject matter of Example 46, wherein the audio, visual, or textual content associated with the particular user is stored on a device connected to the network that is different from a device instantiating the local execution of the virtual environment presented to the particular user.

1. One or more computer-readable storage media comprising instructions that when executed by processing circuitry cause the processing circuitry to:
instantiate a virtual environment comprising a virtual two-dimensional or three-dimensional space in which a plurality of users can interact;
classify interactions by the plurality of users within the virtual environment;
identify a topic of interest for a particular user in the interactions classified based on a topics of interest model for the particular user; and
cause a response action to be initiated in a local execution of the virtual environment presented to the particular user based on the identified topic of interest.

2. The computer-readable storage media of claim 1, wherein the instructions are further to cause the response action to be initiated based on a context of the particular user in the virtual environment.

3. The computer-readable storage media of claim 2, wherein the context of the particular user includes one or more of a location of the particular user within the virtual environment, a vicinity of the particular user with respect to other users within the virtual environment, or an orientation of the particular user within the virtual environment.

4. The computer-readable storage media of claim 1, wherein the instructions are further to cause the response action to be initiated based on a behavior of the particular user.

5. The computer-readable storage media of claim 4, wherein the behavior of the particular user includes one or more of a voice volume of the particular user, a gesture made by the particular user, or a position of the user with respect to a sensor of a device instantiating the local execution of the virtual environment that is presented to the particular user.

6. The computer-readable storage media of claim 1, wherein the instructions are further to cause the response action to be initiated based on a priority indication for the identified topic of interest.

7. The computer-readable storage media of claim 1, wherein the instructions are further to select the response action to be initiated from a set of response actions.

8. The computer-readable storage media of claim 1, wherein the instructions are to classify interaction or identify topics of interest using one of a Latent Dirichlet Allocation (LDA), a large language model (LLM), a natural language processing (NLP) model, and a non-negative matrix factorization (NMF) model.

9. The computer-readable storage media of claim 1, wherein the instructions are to classify interaction or identify topics of interest using a convolutional neural network (CNN) model, a CNN long short-term memory (LTSM) model, or a Vision Transformer (ViT)-based model.

10. The computer-readable storage media of claim 1, wherein the response action includes modifying audio or a visual aspect of the virtual environment presented to the particular user.

11. The computer-readable storage media of claim 10, wherein the response action includes reorienting a display of the virtual environment presented to the particular user.

12. The computer-readable storage media of claim 1, wherein the instructions are further to obtain feedback from the user related to the initiated response action and modify a set of system response actions based on the feedback.

13. The computer-readable storage media of claim 1, wherein the instructions are further to generate the topics of interest model based on audio, visual, or textual content associated with the particular user.

14. The computer-readable storage media of claim 13, wherein the audio, visual, or textual content associated with the particular user is stored on a device instantiating the local execution of the virtual environment presented to the particular user.

15. A method comprising:
instantiating a virtual environment comprising a virtual two-dimensional or three-dimensional space in which a plurality of users can interact;
classifying interactions by the plurality of users within the virtual environment;
identifying a topic of interest for a particular user in the interactions classified based on a topics of interest model for the particular user; and
initiating a response action at a local execution of the virtual environment presented to the particular user based on the identified topic of interest.

16. The method of claim 15, wherein the response action is initiated based on one or more of a context of the particular user in the virtual environment, a behavior of the particular user, and a priority indication for the identified topic of interest.

17. The method of claim 15, wherein the response action includes modifying audio or a visual aspect of the virtual environment presented to the particular user.

18. The method of claim 17, wherein the response action includes reorienting a display of the virtual environment presented to the particular user.

19. A system comprising:
one or more host computing devices to instantiate a virtual environment comprising a virtual two-dimensional or three-dimensional space in which a plurality of users can interact; and
a plurality of user devices connected to the one or more host computing devices over a network, each user device to instantiate a local execution of the virtual environment;
wherein each user device is to:
classify interactions by the plurality of users within the virtual environment;
identify a topic of interest for a particular user in the interactions classified based on a topics of interest model for the particular user; and
cause a response action to be initiated in the local execution of the virtual environment presented to the particular user based on the identified topic of interest.

20. The system of claim 19, wherein each user device is to cause the response action to be initiated based on at least one of context of the particular user in the virtual environment, a behavior of the particular user, and a priority indication for the identified topic of interest.
